(19) United States
(12) Patent Application Publication
(10) Pub. No.: US 2020/0244337 A1
(43) Pub. Date: Jul. 30, 2020

(54) METHODS AND DEVICES FOR PROCESSING AND TRANSMITTING BEAM TRACKING REQUEST

(71) Applicant: NEC CORPORATION, Tokyo (CN)

(72) Inventors: Fang YUAN, Beijing (CN); Lin LIANG, Beijing (CN); Gang WANG, Beijing (CN)

(73) Assignee: NEC CORPORATION, Tokyo (JP)

(21) Appl. No.: 16/651,158

(22) PCT Filed: Sep. 27, 2017
(86) PCT No.: PCT/CN2017/103673

§ 371 Date: Mar. 26, 2020

(51) Int. Cl. H04B 7/06; H04W 74/08; H04W 72/04; H04W 76/27

(52) U.S. Cl. CPC H04B 7/0695; H04W 74/0833; H04W 76/27; H04W 72/0466; H04W 72/046; H04W 72/042

(57) ABSTRACT

Embodiments of the present disclosure relate to a method, terminal device and apparatus for processing a beam tracking request and a method, network device and apparatus for transmitting a beam tracking request. In an embodiment of the present disclosure, the method of processing a beam tracking request may include receiving a beam tracking request containing beam identification information; transmitting a confirmation as a response to the beam tracking request; and performing an operation corresponding to the beam tracking request if an acknowledgement is transmitted as the confirmation. With embodiments of the present disclosure, it is possible to provide a solution with a reduced latency while keeping beam operation reliability, which is important especially for urgent cases.

### FIELD OF THE INVENTION

The non-limiting and exemplary embodiments of the present disclosure generally relate to the field of wireless communication techniques, and more particularly relate to a method, terminal device and apparatus for processing beam tracking request and a method, network device and apparatus for transmitting beam tracking request.

### BACKGROUND OF THE INVENTION

New radio access system, which is also called as NR system or NR network, is the next generation communication system. In Radio Access Network (RAN) #71 meeting for the third generation Partnership Project (3GPP) working group, study of the NR system was approved. The NR system will consider frequency ranging up to 100 Ghz with an object of a single technical framework addressing all usage scenarios, requirements and deployment scenarios defined in Technical Report TR 38.913, which includes requirements such as enhanced mobile broadband, massive machine-type communications, and ultra-reliable and low latency communications.

In 3GPP RAN1 #90, it was agreed that there were two cases regarding beam failures. In a first case, a beam failure is declared only when all serving control channels fail; in a second case, a subset of serving control channels fail, and this event also needs to be handled.

In a beam reporting instance, UE can be configured to report N different transmit (Tx) beams that can be received simultaneously, and UE may report N or fewer beams in a given reporting instance.

Besides, in order to improve robustness of Physical Downlink Control Channels (PDCCH), it was agreed to use multi-beam operations. For illustration purposes, FIG. 1 illustrates possible options for multi-beam operations. In FIG. 1 are illustrated three options using four possible configurations of control channel resource sets (CORESET), CORESET #1 to #4. In option 1, CONRESETs #1 and #2 are a multi-beam operation configured on CORESET level, wherein in CONRESETs #1, all Physical Downlink Control Channels (PDCCH) candidates #1 to candidates #4 are carried on beam 1 illustrated by ellipses filled with dots, in CONRESETs #2, all Physical Downlink Control Channels (PDCCH) candidates #1 to #4 are carried repeatedly on beam 2 illustrated by ellipses filled with crosses. In option 2, CORESET #3 is a multi-beam operation configured on PDCCH level, wherein PDCCH candidates #1 and #2 are carried on beam 1 illustrated by ellipses filled with dots, whereas PDCCH candidates #3 and #4 are carried on beam 2 illustrated by ellipses filled with crosses. In option 3, CORESET #4 is a multi-beam operation configured on resource block group (RBG) or control channel element (CCE) level, wherein one part of each of PDCCH candidates #1 to #4 is carried on beam 1 and the other part thereof is carried on and beam 2.

In multi-beam operations, it is possible that only a subset of serving control channels fail, and in such a case, it requires to handle the partial beam failure.

In 3GPP technical document R1-1713420, there is disclosed a solution for improving beam tracking latency and reliability. As illustrated in FIG. 2, in the proposed solution, when a beam failure is detected by the network, or a beam switch request is received from a terminal device, Downlink Control Information (DCI) will be used as a beam switch signal to inform the terminal device of beam switching; in response to receipt of the DCI, the terminal device transmits an acknowledgement (ACK) to the network within a time interval m; and after a predetermined time period S_{d} expires, the network and the terminal device performs the beam switching simultaneously. In the solution as disclosed, the beam switch is performed only after the ACK transmitted from the terminal device to the network device and it causes a long response time.

In patent application publication WO2017/12306061A1, there is also proposed a beam tracking solution based on random access channel (RACH) procedure. As illustrated in FIG. 3, the terminal device may transmit a RACH preamble which could trigger the beam change/switching, and the network sends an explicit beam change/switching instruction together or separately with Msg 4 to instruct the terminal device change beam. This solution is suitable for the first case of beam failure, i.e., a case that all beams fail and similarly, it might lead to additional processing delay as well.

### SUMMARY OF THE INVENTION

To this end, in the present disclosure, there is provided a new solution for beam tracking request, to mitigate or at least alleviate at least part of the issues in the prior art.

According to a first aspect of the present disclosure, there is provided a method of processing a beam tracking request. The method may comprise receiving a beam tracking request containing beam identification information; transmitting a confirmation as a response to the beam tracking request; and performing an operation corresponding to the beam tracking request if an acknowledgement is transmitted as the confirmation.

According to a second aspect of the present disclosure, there is provided a method for transmitting a beam tracking request. The method may comprise transmitting a beam tracking request containing beam identification information; receiving a confirmation as a response to the beam tracking request; and performing an operation corresponding to the beam tracking request in response to receiving an acknowledgement as the confirmation.

According to a third aspect of the present disclosure, there is provided a network node. The network node may comprise a transceiver, configured to receive a beam tracking request containing beam identification information, and transmit a confirmation as a response to the beam tracking request; and a processor, configured to perform an operation corresponding to the beam tracking request if an acknowledgement is transmitted as the confirmation.

According to a fourth aspect of the present disclosure, there is provided a terminal device. The terminal device may comprise a transceiver, configured to transmit a beam tracking request containing beam identification information and receive a confirmation as a response to the beam tracking request; and a processor, configured to perform an operation corresponding to the beam tracking request in response to receiving an acknowledgement as the confirmation.

According to a fifth aspect of the present disclosure, there is provided a network device. The network device may comprise a processor and a memory. The memory may be coupled with the processor and having program codes therein, which, when executed on the processor, cause the network device to perform operations of the second aspect.

According to a sixth aspect of the present disclosure, there is provided a terminal device. The terminal device may comprise a processor and a memory. The memory may be coupled with the processor and have program codes therein, which, when executed on the processor, cause the terminal device to perform operations of the first aspect.

According to a seventh aspect of the present disclosure, there is provided a computer-readable storage media with computer program codes embodied thereon, the computer program codes configured to, when executed, cause an apparatus to perform actions in the method according to any embodiment in the first aspect.

According to an eighth aspect of the present disclosure, there is provided a computer-readable storage media with computer program codes embodied thereon, the computer program codes configured to, when executed, cause an apparatus to perform actions in the method according to any embodiment in the second aspect.

According to a ninth aspect of the present disclosure, there is provided a computer program product comprising a computer-readable storage media according to the seventh aspect.

According to a tenth aspect of the present disclosure, there is provided a computer program product comprising a computer-readable storage media according to the eighth aspect.

With embodiments of the present disclosure, it is possible to provide a solution with a reduced latency while keeping beam operation reliability, which is important especially for urgent cases.

### BRIEF DESCRIPTION OF THE DRAWINGS

The above and other features of the present disclosure will become more apparent through detailed explanation on the embodiments as illustrated in the embodiments with reference to the accompanying drawings, throughout which like reference numbers represent same or similar components and wherein:

FIG. 1 schematically illustrates possible options for multi-beam operations;

FIG. 2 schematically illustrates an existing solution for improving beam tracking latency and reliability;

FIG. 3 schematically illustrates network based beam tracking via Random Access Channel (RACH) procedure;

FIG. 4 schematically illustrates a flow chart of a method for processing a beam tracking request according to an embodiment of the present disclosure;

FIGS. 5A to 5E schematically illustrate example transmission options of confirmation of beam tracking request according to embodiments of the present disclosure;

FIG. 6 schematically illustrates possible signal paths according to an embodiment of the present disclosure;

FIGS. 7A to 7D schematically illustrate example operations corresponding to the beam tracking request according to embodiments of the present disclosure;

FIG. 8 schematically illustrates a signaling diagram of beam tracking procedure according to an embodiment of the present disclosure;

FIGS. 9A to 9C schematically illustrates an example possible PDCCH transmission options according to an embodiment of the present disclosure;

FIGS. 10A and 10B schematically illustrate example beam set updating according to embodiments of the present disclosure;

FIG. 11 schematically illustrates example failed beam indication according to embodiments of the present disclosure;

FIGS. 12A and 12B schematically illustrate example beam quality indication according to embodiments of the present disclosure;

FIG. 13 schematically illustrates a flow chart of a method for transmitting a beam tracking request according to an embodiment of the present disclosure;

FIG. 14 schematically illustrates a block diagram of an apparatus for processing a beam tracking request according to an embodiment of the present disclosure;

FIG. 15 schematically illustrates a block diagram of an apparatus for transmitting a beam tracking request according to an embodiment of the present disclosure; and

FIG. 16 schematically illustrates a simplified block diagram of an apparatus 1610 that may be embodied as or comprised in a network device like gNB, and an apparatus 1620 that may be embodied as or comprised in a terminal device like UE as described herein.

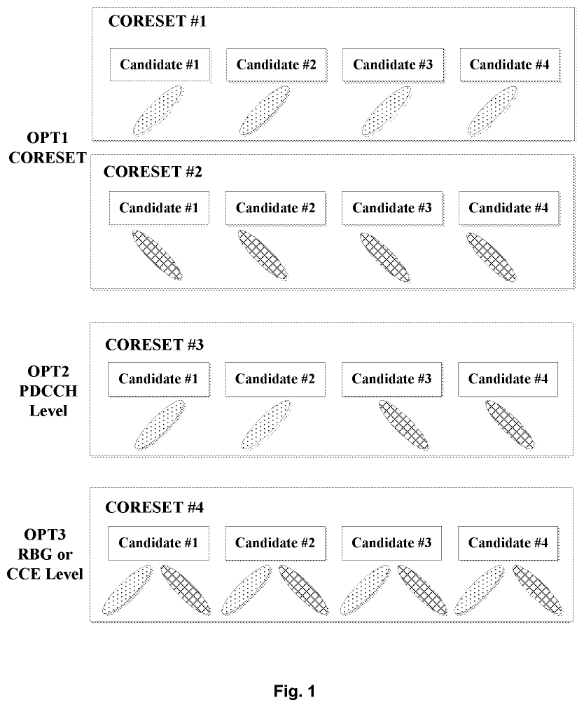

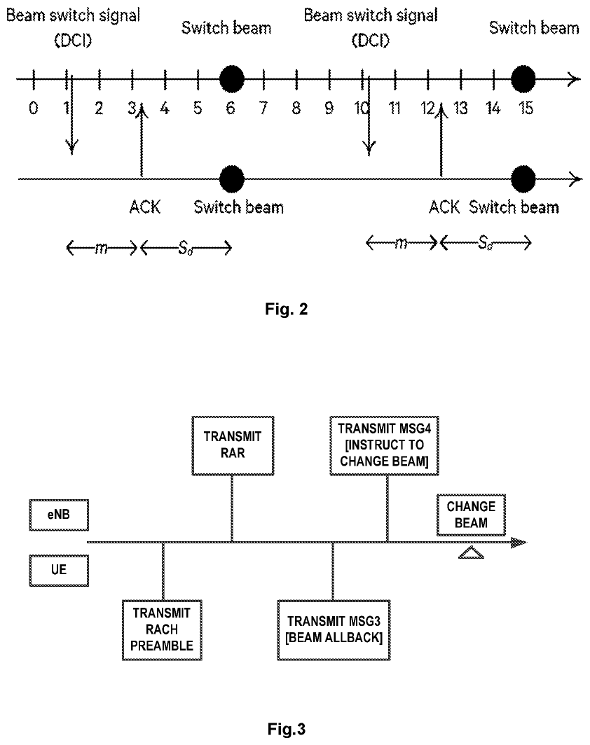

### DETAILED DESCRIPTION OF EMBODIMENTS

Hereinafter, the solution as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

Generally, all terms used in the claims are to be interpreted according to their ordinary meaning in the technical field, unless explicitly defined otherwise herein. All references to “a/an/the/said [element, device, component, means, step, etc.]” are to be interpreted openly as referring to at least one instance of said element, device, component, means, unit, step, etc., without excluding a plurality of such devices, components, means, units, steps, etc., unless explicitly stated otherwise. Besides, the indefinite article “a/an” as used herein does not exclude a plurality of such steps, units, modules, devices, and objects, and etc.

Additionally, in a context of the present disclosure, user equipment (UE) may refer to a terminal, a Mobile Terminal (MT), a subscriber station, a portable subscriber station, Mobile Station (MS), or an Access Terminal (AT), and some or all of the functions of the UE, the terminal, the MT, the SS, the portable subscriber station, the MS, or the AT may be included. Furthermore, in the context of the present disclosure, the term “BS” may represent, e.g., a node B (NodeB or NB), an evolved NodeB (eNodeB or eNB), gNB (next generation Node B), a radio header (RH), a remote radio head (RRH), a relay, or a low power node such as a femto, a pico, and so on.

As mentioned in background, the existing solutions are network based beam switch solutions, which might lead to additional processing delay. To this end, in the present disclosure, there is proposed a new solution for beam tracking request to reduce the processing delay. In the proposed solution, a request and grant mode will be adopted, wherein an explicit “grant” for the beam tracking request can enable the corresponding operations to be performed without additional delay.

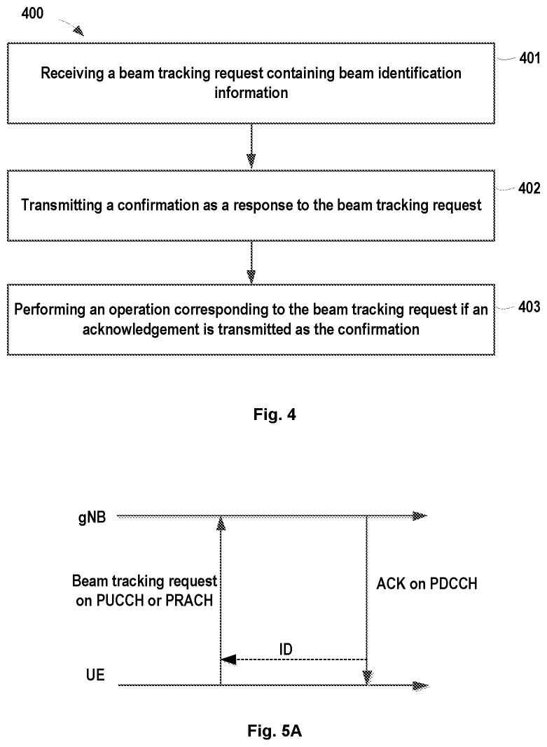

Hereinafter, reference will be further made to FIGS. 4 to 16 to describe the solution as proposed in the present disclosure in details. It shall be appreciated that the following embodiments are given only for illustration purposes and the present disclosure is not limited thereto.

Reference is first made to FIG. 4, which schematically illustrates a flow chart of a method of processing a beam tracking request according to an embodiment of the present disclosure. The method 400 can be performed at a network device or a network node, for example gNB, or other like network device.

As illustrated in FIG. 4, first in step 401, the network device may receive a beam tracking request from a terminal device. During beam monitoring, the terminal device may detect that a serving beam fails, there is a new beam, or it needs a beam switching from a degraded beam to a better beam, etc., and in such case, the terminal device may transmit a beam tracking request to the network device. The beam tracking request may include beam identification information, so that the network can learn an operation corresponding to the beam tracking request can be performed. The beam identification information may include for example, failed beam ID, new beam ID or both of them. The beam tracking request may further comprise beam tracking type information if necessary. The beam tracking type information may be not explicitly transmitted when there is a default beam tracking type if beam tracking contains only beam identification information. The type of beam tracking request includes but not limited to: (1) a request for beam switching from a degraded serving beam to a better beam; (2) a request for removing a failed beam from the current serving beam set; (3) a request for adding a new beam to the current serving beam set; (4) a request for beam recovery with no further beam management, the beam recovery recovering the downlink failed beam by using a new beam provided by the terminal device. The beam tracking request may be transmitted on Physical Uplink Control Channel (PUCCH). As another example, the beam tracking request can also be transmitted on Physical Random Channel (PRACH).

Next, in step 402, the network device may transmit a confirmation as a response to the beam tracking request. Upon receiving the beam tracking request, if the network device decides to perform operations corresponding to the beam tracking request, it immediately transmits a positive confirmation of the beam tracking request to the terminal device. The positive confirmation can be, for example, an acknowledgement (ACK). If the network decides not to perform any operation corresponding to the beam tracking request, the network could transmit a negative acknowledgement (NACK) to explicitly inform the terminal device, or just transmit nothing to implicitly inform the terminal device. Hereinafter, for illustration purposes, ACK will be taken as an example of confirmation, and the skilled in the art can understand some description of ACK can applied to NACK as well.

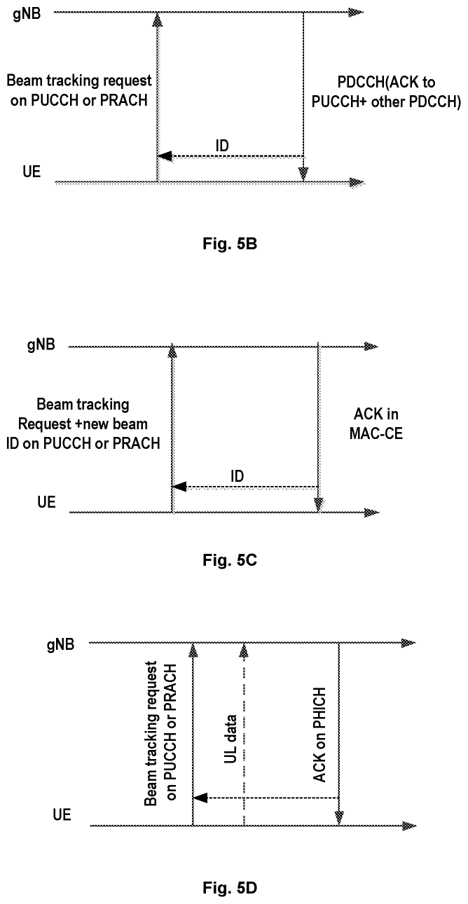

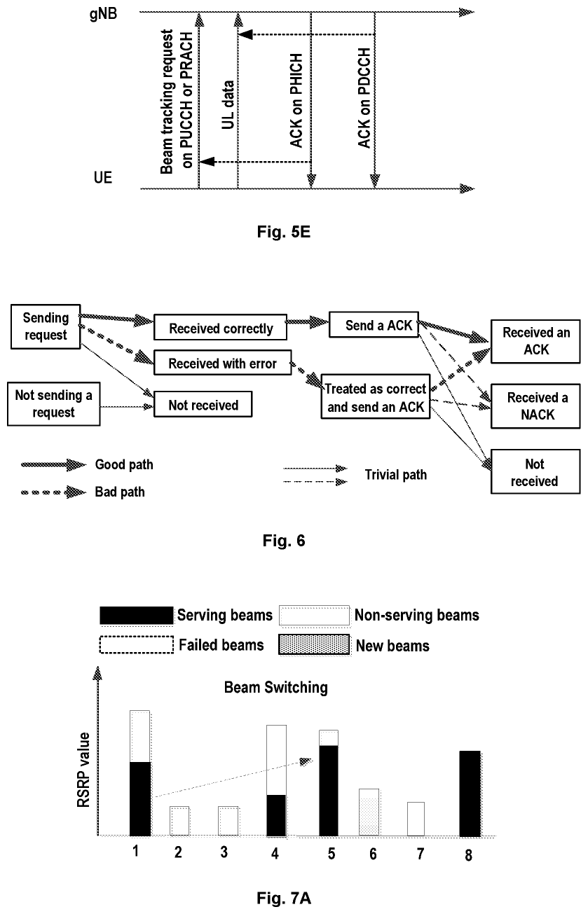

In an embodiment of the present disclosure, the confirmation can be transmitted in Physical Downlink Control Channel (PDCCH). As illustrated in FIG. 5A, the beam tracking request can be carried by the PUCCH or the PRACH, and the ACK could be contained in DCI on the PDCCH. In such a case, there are serval options for carrying ACK/NACK.

In an option, the ACK can be indicated by a PDCCH scrambled by a terminal device identity, without any other content like Time Advance (TA), Resource Allocation (RA), Quasi-colocation (QCL) indicator contained therein. In other words, if the terminal device descrambles the PDCCH successfully, it means an ACK for the previously transmitted beam tracking request. The terminal device identity for scrambling/descrambling the PDCCH may be a special purpose identity that is only used for beam tracking purpose, or can reuse an identity for other purpose. Further, the terminal device identity can be determined based on a specific random sequence, time-frequency resource assignment, or a CRC code, etc.

In another option, the ACK/NACK can be indicated by a bit corresponding to a target terminal device in a PDCCH scrambled by an identity common to a group of terminal devices, like the DCI format 3 in LTE. The DCI carried by the PDCCH contains a plurality of bit fields, each of which is dedicated to one of terminal devices in the group. Thus, the group of terminal device could receive the PDCCH and each of the terminal devices could obtain its ACK/NACK on a bit field dedicated to the terminal device.

In a further option, it is possible to add a new bit in DCI of PDCCH, where in the DCI may contain other content, e.g., TA, RA, or Quasi-colocation (QCL) indicator. In other words, the ACK/NACK can be indicated by a new bit in DCI of the PDCCH.

In a still further option, the ACK can be indicated by information repeating the beam tracking request in PDCCH. In other words, the beam tracking request can be retransmitted in the PDCCH such that it can contain the same information as those contained in the beam tracking request, to enable the terminal device to identify it as an ACK for the beam tracking request.

FIG. 5B schematically illustrates another example transmission option of confirmation of beam tracking request according to an embodiment of the present disclosure. As illustrated in FIG. 5B, the beam tracking request can be carried by the PUCCH or the PRACH, and the ACK could be contained in DCI on the PDCCH; however different from FIG. 5A, PDCCH contains two parts, wherein one part contains newly added bit for ACK of PUCCH and the other part is DCI for other purposes.

FIG. 5C schematically illustrates a further example transmission option of configuration of beam tracking request according to an embodiment of the present disclosure. In FIG. 5C, the beam tracking request can be carried by PUCCH or PRACH, and the ACK for the beam tracking request can be carried in MAC-CE to inform the terminal device of the confirmation.

FIG. 5D schematically illustrates a still further example transmission option of confirmation of beam tracking request according to an embodiment of the present disclosure. In FIG. 5D, the beam tracking request can be carried by PUCCH or PRACH, and the ACK for the beam tracking request can be carried in Physical Hybrid-ARQ Indicator Channel (PHICH) if there is no uplink data transmission. In such a case, the downlink resource of PHICH to a terminal device can be based on its resource allocation of PUCCH and ID of DMRS.

FIG. 5E schematically illustrates a yet further example transmission option of confirmation of beam tracking request according to an embodiment of the present disclosure. In FIG. 5E, the beam tracking request and the uplink data are transmitted at the same time, and confirmations for the two transmissions are required. In such a case, the beam tracking request can be carried by PUCCH or PRACH, and the ACK for the beam tracking request and the ACK for uplink data transmission on PUSCH can be carried by PHICH and PDCCH respectively. For example, the confirmation of the beam tracking request can be transmitted on the PDCCH and a confirmation of uplink data transmission on PUSCH can be transmitted on the PHICH. As another example, the confirmation of the beam tracking request can be transmitted on the PHICH and the confirmation of the uplink data transmission on PUSCH is transmitted on the PDCCH.

The confirmations of the beam tracking request and uplink data transmission can also be transmitted in another way. For example, the confirmation of the beam tracking request can be multiplexed with a confirmation of uplink data transmission on PUSCH. The multiplexing can use any of frequency division multiplexing or code division multiplexing.

In addition, the confirmations of the beam tracking request and uplink data transmission can be bundled together. In other words, the confirmation of the beam tracking request can further indicate a confirmation of uplink data transmission on PUSCH. For illustration purposes, two example bundling settings A and B are given
Setting A:
1. Data ACK+Beam Tracking Request ACK=ACK
2. Data NACK+Beam Tracking Request NACK=NACK
3A. Data NACK+Beam Tracking Request ACK=NACK
4A. Data ACK+Beam Tracking Request NACK=ACK
Setting B:
1. Data ACK+Beam Tracking Request ACK=ACK
2. Data NACK+Beam Tracking Request NACK=NACK
3B. Data NACK+Beam Tracking Request ACK=ACK
4B. Data ACK+Beam Tracking Request NACK=NACK

The choosing of setting A or setting B can be configured by Radio Resource Control (RRC) signaling to the terminal device. The network device may send a confirmation by using the configured setting, and accordingly the terminal device may interpret the confirmation based on the setting configured by the RRC signaling.

It shall be appreciated that for the bundling setting and resource multiplexing as described hereinabove, the confirmation for uplink data and beam tracking request may have the same or different priority, the PUCCH carrying the beam tracking request and PUSCH carrying the uplink data shall be located within the same time slot. In addition, it can also be appreciated that the ACK can be either on PHICH or on PDCCH.

Reference is made back to FIG. 4, in step 403, the network performs an operation corresponding to the beam tracking request if an ACK is transmitted as a response to the beam tracking request. The operation may include beam switching, failed beam removing, new beam adding, beam recovery with no further beam management, or any other predefined beam tracking type. Hereinafter, reference is made to FIG. 6 to describe these operations.

FIG. 6 schematically illustrates possible signal paths according to an embodiment of the present disclosure. From FIG. 6, it can be seen that the good path are desired signal paths and the trivial paths are possible paths but will not cause any severe system impact; while bad paths are undesirable paths which could lead to severe system impact. In order to tackle this issue, it is proposed to use some improved schemes. For example, it is possible to not explicitly transmit a NACK from the network device to terminal device. Thus, no ACK or no transmission can be understood as a NACK at the terminal device. As another example, the beam tracking request transmitted in Uplink Control Information (UCI) of PUCCH can be attached with a CRC. Thus, the network can perform a CRC check to detect the decoding error so as to avoid the possibility of incorrect receiving, which in turn prevents sending possible misleading confirmation as a response to the beam tracking request from the terminal device. In addition, it is also possible for the network device to repeat the beam tracking request of the terminal device in DCI of PDCCH. In such a way, the possibility of misunderstanding at the terminal device will be reduced accordingly.

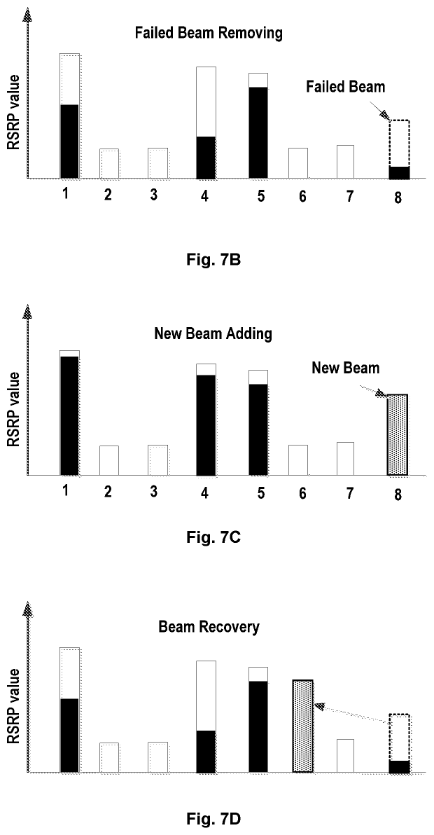

FIGS. 7A to 7D further schematically illustrate example operations performed corresponding to the different types of beam tracking request according to embodiments of the present disclosure. FIG. 7A illustrates a beam switching operation corresponding to one type of beam tracking request according to an embodiment of the present disclosure. As illustrated in FIG. 7A, in response to a beam tracking request, the transmission will be switched from a beam with lower channel quality in the serving beam subset to another beam with a better channel quality in the serving beam subset. FIG. 7B illustrates a failed beam removing operation corresponding to another type of the beam tracking request according to an embodiment of the present disclosure. As illustrated in FIG. 7B, in response to a beam tracking request, a failed beam in the serving beam subset, as indicated by the beam tracking request, will be removed from the serving beam subset. FIG. 7C illustrates a new beam adding operation corresponding to another type of the beam tracking request according to an embodiment of the present disclosure. As illustrated in FIG. 7C, in response to a beam tracking request, a new beam with good channel quality will be added into the serving beam subset. FIG. 7D illustrates a beam recovery operation with no further beam management corresponding to the beam tracking request according to embodiments of the present disclosure. As illustrated in FIG. 7D, in response to a beam tracking request, a new beam with good channel quality will replace a failed beam for downlink transmission in the serving beam subset. The beam tracking request may contain the beam identification information, and if necessary, it may further contain the beam tracking type information which specifies the exact beam tracking type to the network device. The beam tracking type information may be information for indicating beam switching, failed beam removing, new beam adding, beam recovery operation with no further beam management, and any other preconfigured beam tracking type. The set of preconfigured beam tracking types can be configured by RRC signaling to the terminal device. One of beam tracking types may be implicitly set as the default beam tracking type, or the RRC signaling may explicitly configure one of beam tracking types as a default. For example, the beam recovery request can be defaulted at both network device and terminal device. In such a case, the beam tracking request may contain only the beam identification information, and the default beam tracking type will performed at both at both network device and terminal device in response to the beam tracking request.

It can be appreciated that beam tracking operations can be requested on UCI in PUCCH through beam tracking request and acknowledged in PDCCH or PHICH. In addition, a subset in which beams do not fail can be used to deliver necessary DL signaling.

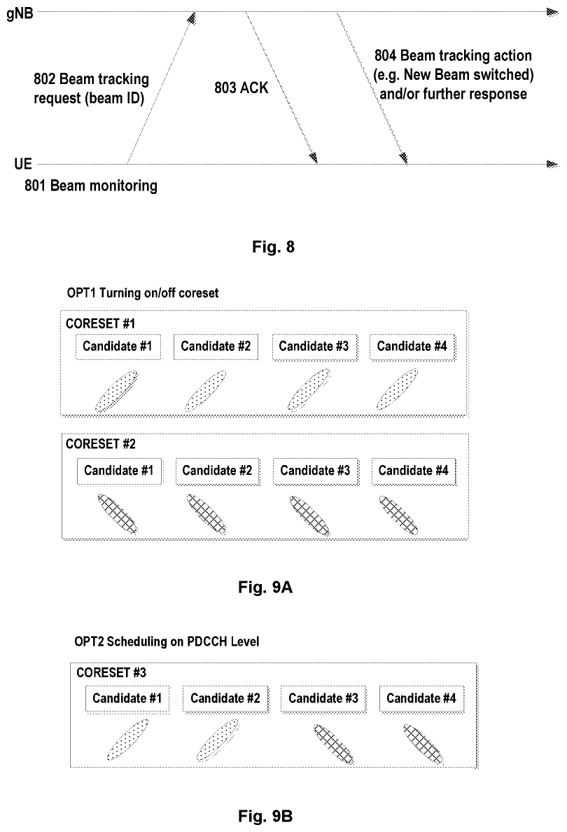

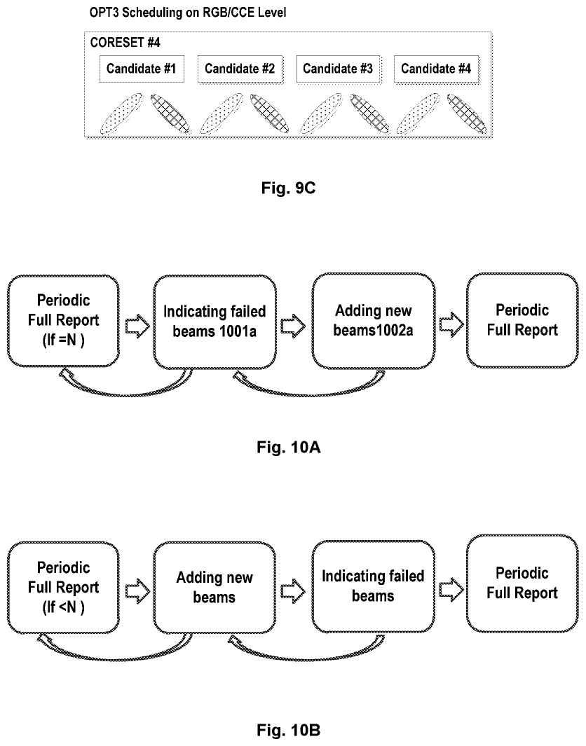

FIG. 8 schematically illustrates a signaling diagram of beam tracking procedure according to an embodiment of the present disclosure. As illustrated in FIG. 8, first at step 801, the terminal device like UE performs beam monitoring. Once it is determined based on the beam monitoring that it is a necessary to send a beam tracking request, UE sends, at step 802, a beam tracking request at least with beam ID to the network, gNB. Upon receiving the beam tracking request, the gNB, if necessary, will send an ACK as a response to UE's request at step 803. The response signaling will be offloaded to survived DL beams. Meanwhile, UE may expect to only receive a response on the survived DL beams. For example, the ACK signal will be transmitted on one of survived beams requested by the UE. The beam tracking operations can be performed simultaneously at the network device and the terminal device after a preconfigured time offset from the ACK transmission/reception. The preconfigured time offset can be configured by a RRC signaling, and or an MAC CE signaling.

In such a case, the gNB need s to perform additional operations. For example, it may turn on/off CORESET #1 or #2, as illustrated in FIG. 9A; it may select rescheduling the PDCCH candidates on PDCCH level, as illustrated in FIG. 9B; or alternatively, the gNB may reassign resources for the PDCCH candidates on CCE or RGB level, as illustrated in FIG. 9C.

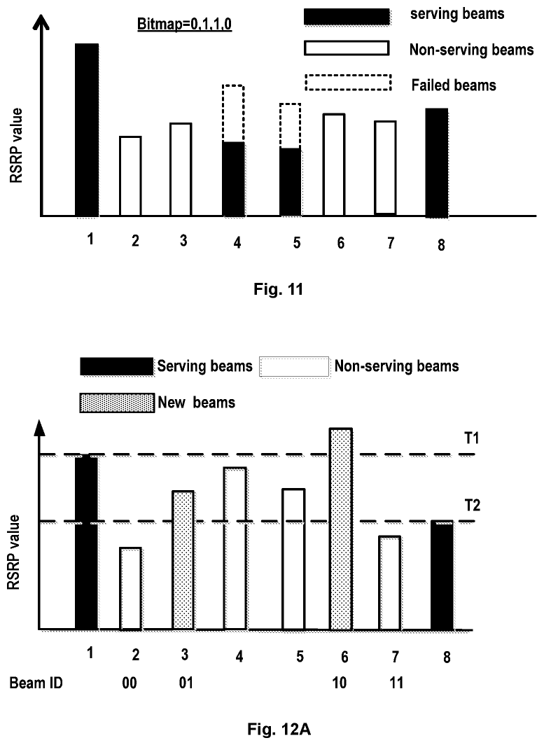

In addition, the proposed solution may enable a flexible beam set updating between two periodic full reports. As illustrated in FIG. 10A, when the serving beam subset contains a required number of beams, the terminal device may send a beam tracking request when there is a failed beam (1001a) to remove the failed beam, and send another beam tracking request when there is a new beam with a good channel quality (1002a) to add the new beam. In another embodiment as illustrated in FIG. 10B, when the serving beams subset contains less beams than required, the terminal device may first send a beam tracking request when there is a new beam with a good channel quality (1001b) to add the new beam and send another beam tracking request when there is a failed beam to remove the failed beam (1002b). By means of the simple atomic operations, the serving beam subset can be updated in a flexible way.

In an embodiment of the present disclosure, the beam identification information contained in the beam tracking request can be indicated in a more efficient way. For example, the UCI may have UCI field 1, which is used to indicate failed serving beams by a low overhead bitmap. In the proposed indication scheme, the beam identification information indicates a beam identification based on a serving beam set. For example, the bitmap refers to only the current serving beam subset, i.e., previously reported or acknowledged serving subset. For example, as illustrated in FIG. 11, there are 8 beams and thus the full beam set={1, 2, 3, 4, 5, 6, 7, 8}; while there are only four serving beams currently, and thus the current serving beam subset={1, 4, 5, 8}. If beams 4 and beam 5 fail, the bitmap can be 0 1 1 0, i.e. indicating the second and third beams in the current serving beam set, without considering the full beam set. In such a way, only a bitmap with 4 bit is enough. It shall be appreciated that the bitmap can be used to indicate both the failed beam and the new beam.

In another embodiment of the present disclosure, the UCI may be further provided another UCI filed 2, which contains beam channel quality information and the beam channel quality information is indicated by a beam quality pattern representing a quality relationship of reported beams with respect to survived beams in the serving beam set.

The term “beam quality pattern” used herein is a pattern which indicates a quality relationship of respective beams with respect to the beam quality thresholds. Particularly, the beam quality pattern could indicate threshold ranges which the respective beam are located within. Therefore, different from the existing solution, the information on the beam quality pattern can be transmitted to the network device, to provide rough information of the beam quality.

The term “the beam quality” used herein refers to information that can reflect the channel quality of beams and it can also be called in another way, such as beam measurement quantity, beam measurement value, CQI of the beam, etc. As an example, the beam quality can be indicated by Reference Signal Receiving Power (RSRP) of a beam. Hereinafter, the RSRP will be taken as an example of the beam quality information; however, the skilled in the art can readily understand that it is given just for illustration purposes and the present disclosure is not limited thereto, and in practice, it is possible to use any other measurements to reflect the beam quality.

For example, the UCI filed in PUCCH carrying beam tracking request can contain new serving beam ID and optionally beam channel quality ordering information. The ordering information may further contain two parts: ordered subset and beam quality pattern. The beam quality pattern can be determined based on the beam quality of survived beams in the serving beam set. Particularly, the beam quality of survived beams can be used as beam quality thresholds. As illustrated in FIG. 12A, there are four non-serving node, {2, 3, 6, 7} and beams {3, 6} are new beams to be added into the serving beam subset. The ordered subset can be {10, 01} and the RSRP values T1 and T2 of survived beams 1 and 8 can be used as beam quality thresholds for the beam quality pattern. As further illustrated in FIG. 12B, there are four possible beam quality relationships between two beams. The terminal device may determine the pattern of beams 4 and 5 and contains it in the UCI filed 2. Regarding the example as illustrated in FIG. 12, the pattern is patter B, which can indicated by 10 for example. After receiving the information, the gNB could learn the ordering information as contained within the UCI based on the reference threshold T1 and T2.

In an embodiment of the present disclosure, there are further proposed possible RSRP tables for different reference signals (RS). In the proposed solution, different RSRP dynamic range can be used for different reference signals. For example, the synchronization signal blocks can have a smaller RSRP dynamic range than Periodic Channel State Information (P-CSI) RS, and the periodically CSI RS has a smaller RSRP dynamic range than the Aperiodic Channel State Information (AP-CSI) RS. For illustration purposes, Tables 1 to 3 are given to show example RSRP tables. The smaller dynamic range corresponding to a smaller number of RSRP states can result in a less RSRP reporting overhead from the terminal device to the network device.

TABLE 1
RSRP reporting mapping for AP-CSI

| AP-CSI | RSRP (dBm) |
|---|---|
| RSRP_00 | RSRP < −140 |
| RSRP_01 | −140 ≤ RSRP < −139 |
| . . . | . . . |
| RSRP_96 | −45 ≤ RSRP < −44 |
| RSRP_97 | −44 ≤ RSRP |

TABLE 2
RSRP reporting mapping for P-CSI

| P-CSI | RSRP (dBm) |
|---|---|
| RSRP_00 | RSRP < −140 |
| RSRP_01 | −140 ≤ RSRP < −139 |
| . . . | . . . |
| RSRP_64 | −77 ≤ RSRP < −76 |
| RSRP_65 | −76 ≤ RSRP |

TABLE 3
SRP reporting mapping for SSB

| P-CSI | RSRP (dBm) |
|---|---|
| RSRP_00 | RSRP < −140 |
| RSRP_01 | −140 ≤ RSRP < −139 |
| . . . | . . . |
| RSRP_64 | −77 ≤ RSRP < −76 |
| RSRP_65 | −76 ≤ RSRP |

Thus, in the proposed solution, the terminal device will select RSRP reporting mapping based on the type of the reference signals. At the network sides, after receiving the RSRP index, the gNB first determines the RSRP mapping table to be used based on the type of reference signals and then obtains the reported RSRP values from the determined mapping table using the RSRP index.

In another embodiment of the present disclosure, it is also possible to use only one standard RSRP table but different reference signal only uses RSRP index corresponding to their respective threshold ranges. In addition, for different types of reference signals, it may also use different shift values. For example, it is possible to provide Table 1 as a standard mapping table and for the SSB, the standard mapping table can be used; while for the P-CSI, a shift value 10 dBm can be applied to each of RSRP thresholds to obtain a new table for the P-CSI. Or alternatively, it may use the same standard table, but a corresponding shift value can be applied to the RSRP values every time to obtain modified RSRP values for the P-CSI.

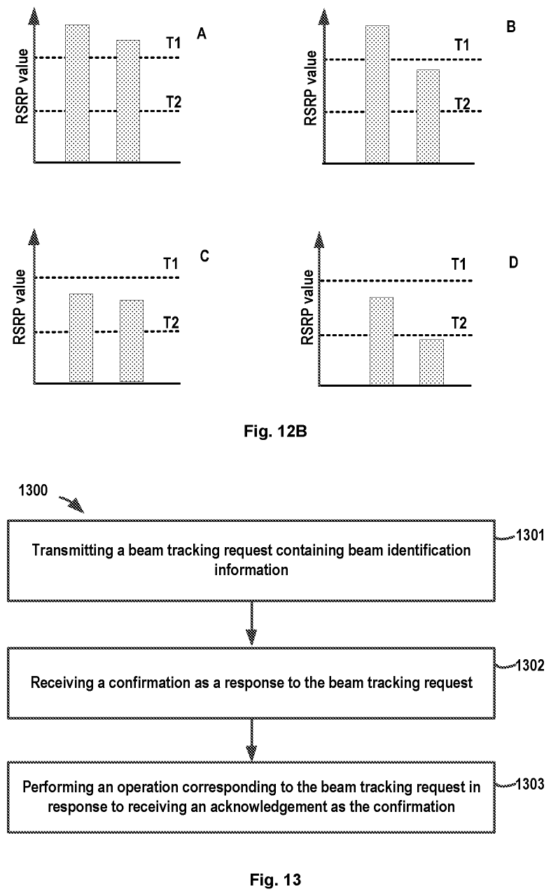

FIG. 13 illustrates schematically illustrates a flow chart of a method 1300 of receiving a beam tracking request according to an embodiment of the present disclosure. The method 1300 can be performed at a terminal device, for example UE, or other like terminal devices.

As illustrated in FIG. 13, first in step 1301, the terminal device may transmit a beam tracking request containing beam identification information. At the terminal device side, the terminal device may monitor all beams, if the triggering condition is met, the terminal device may transmit a beam tracking request to the network device. The beam tracking request may include beam identification information so that the network can learn an operation to be performed corresponding to the beam tracking request. The beam identification information may include for example, failed beam ID, new beam ID or both of them. The beam tracking request may further comprise beam tracking type information if necessary. The beam tracking type information may be not transmitted in beam tracking request when there is a default beam tracking type for a beam tracking request containing only beam identification information. The type of beam tracking request includes but not limited to: (1) a request for beam switching from a degraded serving beam to a better beam; (2) a request for removing a failed beam from the current serving beam set; (3) a request for adding a new beam to the current serving beam set; (4) a request beam recovery with no further beam management, the beam recovery recovering the downlink failed beam by using a new beam provided by the terminal device. The beam tracking request may be transmitted on Physical Uplink Control Channel (PUCCH). As another example, the beam tracking request can also be transmitted on Physical Random Channel (PRACH)

Next, at step 1302, the terminal device may receive a confirmation as a response to the beam tracking request. Upon receiving the beam tracking request, if the network decides to perform operations corresponding the beam tracking request, it will immediately transmit a positive confirmation of the beam tracking request to the terminal device. In such a case, the terminal device can receive a confirmation of the beam tracking request from the network device. The positive confirmation can be for example an ACK. If necessary, the network could transmit a NACK to explicitly inform the terminal device, or just transmit nothing to implicitly inform the terminal device.

The confirmation can be received in PDCCH. For example, the confirmation can be indicated by any of a PDCCH scrambled by a terminal device identity. As an example, the confirmation can be indicated by a bit corresponding to a target terminal device in a PDCCH scrambled by an identity common to a group of terminal devices. As another example, the confirmation can be indicated by a new bit in Downlink Control Information (DCI) of PDCCH. As a further example, the confirmation can be indicated by information repeating the beam tracking request in PDCCH. For details for the confirmation transmission options on PDCCH, one may refer to FIGS. 5A to 5E.

The confirmation can also be carried by MAC CE. In addition, PHICH can be used to carry the confirmation as well. For example, the confirmation of the beam tracking request can be transmitted on the PHICH and the confirmation of the uplink data transmission on PUSCH is transmitted on PDCCH. As another example, the confirmation of the beam tracking request can be transmitted on PDCCH and a confirmation of uplink data transmission on PUSCH can be transmitted on PHICH.

The confirmation can also multiplexed with a confirmation of uplink data transmission on Physical Uplink Shared Channel (PUSCH) in any of frequency division multiplexing or code division multiplexing. Moreover, the confirmation may be bundled with a confirmation of uplink data transmission on PUSCH. In other words, the confirmation may further indicate a confirmation of uplink data transmission on PUSCH.

In order to prevent signals from bad paths, there are serval schemes. In an embodiment of the present disclosure, the confirmation may comprise only acknowledgement for the beam tracking request and no negative acknowledgement for the beam tracking request is transmitted. In another embodiment of the present disclosure, the beam tracking request is transmitted with Cyclic Redundancy Check (CRC) codes. In addition, the beam tracking request can be retransmitted in PDCCH.

In another embodiment of the present disclosure, the beam tracking request is transmitted between two full beam reports to provide a flexible serving beam updating.

In another embodiment of the present disclosure, the beam tracking request further contains beam channel quality information and the beam channel quality information is indicated by a beam quality pattern representing a quality relationship of reported beams with respect to survived beams in the serving beam set. By means of the beam quality pattern, it is possible to report the RSRP in an efficient way.

In response to the receipt of ACK, the terminal device may perform an operation corresponding to the beam tracking request in response to receiving an acknowledgement as the confirmation at step 1303. The beam tracking request corresponds to any operation of: beam switching; failed beam removing; new beam adding; and beam recovery with no further beam management.

Hereinabove, embodiments of the method of receiving a beam tracking request are described in brief hereinbefore with reference to FIG. 13. However, it can be understood that operations at the terminal device are corresponding to those at the network device and thus for some details of operations, one may refer to description with reference to FIGS. 4 to 12.

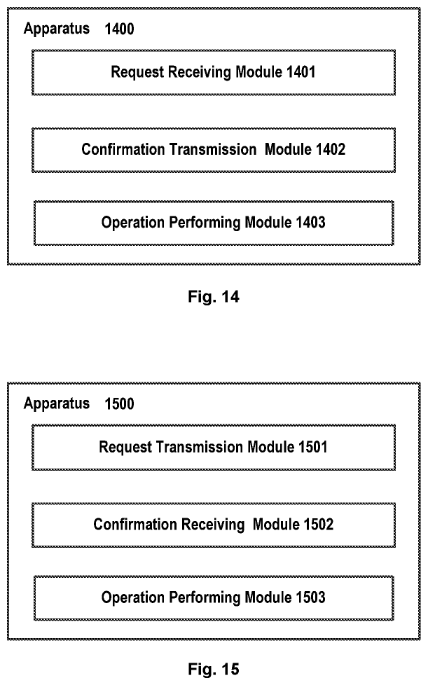

FIG. 14 schematically illustrates a block diagram of an apparatus for processing a beam tracking request according to an embodiment of the present disclosure. Apparatus 1400 can be implemented at a network device such as the gNB.

As illustrated in FIG. 14, apparatus 1400 may include a request receiving module 1401, a confirmation transmission module 1402 and an operation performing module 1403. The request receiving module 1401 may be configured to receive a beam tracking request containing beam identification information. The confirmation transmission module 1402 may be configured to transmit a confirmation as a response to the beam tracking request. The operation performing module 1403 may be configured to perform an operation corresponding to the beam tracking request if an acknowledgement is transmitted as the confirmation.

In an embodiment of the preset disclosure, the confirmation may be transmitted in any of: PDCCH; MAC CE; and PHICH.

In another embodiment of the preset disclosure, the confirmation may be multiplexed with a confirmation of uplink data transmission on PUSCH in any of frequency division multiplexing or code division multiplexing.

In a further embodiment of the preset disclosure, the confirmation may further indicate a confirmation of uplink data transmission on PUSCH.

In a still further embodiment of the preset disclosure, the confirmation may be indicated by any of: a PDCCH scrambled by a terminal device identity; a bit corresponding to a target terminal device in a PDCCH scrambled by an identity common to a group of terminal devices; a new bit in Downlink Control Information of PDCCH; and information repeating the beam tracking request in PDCCH.

In another embodiment of the preset disclosure, the confirmation may comprise only acknowledgement for the beam tracking request and no negative acknowledgement for the beam tracking request is transmitted.

In a further embodiment of the preset disclosure, the beam tracking request may contain CRC codes.

In an embodiment of the preset disclosure, the beam tracking request may be received between two full beam reports.

In another embodiment of the preset disclosure, the beam identification information may indicate a beam identification based on a serving beam set.

In an embodiment of the preset disclosure, the beam tracking request may further contain beam channel quality information. The beam channel quality information may be indicated by a beam quality pattern representing a quality relationship of reported beams respect to survived beams in the serving beam set.

In an embodiment of the preset disclosure, the beam tracking request may correspond to any operation of: beam switching; failed beam removing; new beam adding; and beam recovery with no further beam management.

FIG. 15 schematically illustrates a block diagram of an apparatus for receiving a beam tracking request according to an embodiment of the present disclosure. Apparatus 1500 can be implemented at a terminal device such as UE.

As illustrated in FIG. 15, apparatus 1500 may include a request transmission module 1501, a confirmation receiving module 1502 and an operation performing module 1503. The request transmission module 1501 may be configured to transmit a beam tracking request containing beam identification information. The confirmation receiving module 1502 may be configured to receive a confirmation as a response to the beam tracking request. The operation performing module 1503 may be configured to perform an operation corresponding to the beam tracking request if an acknowledgement is transmitted as the confirmation.

In an embodiment of the present disclosure, the confirmation may be received in any of PDCCH, MAC CE, and PHICH.

In another embodiment of the present disclosure, the confirmation may be multiplexed with a confirmation of uplink data transmission on PUSCH in any of frequency division multiplexing or code division multiplexing.

In a further embodiment of the present disclosure, the confirmation may further indicate a confirmation of uplink data transmission on PUSCH.

In a still further embodiment of the present disclosure, the confirmation may be indicated by any of: a PDCCH scrambled by a predetermined terminal device identity; a bit corresponding to a target terminal device in a PDCCH scrambled by an identity common to a group of terminal devices; a new bit in Downlink Control Information of PDCCH; and information repeating the beam tracking request in PDCCH.

In a yet further embodiment of the present disclosure, the confirmation may comprise only acknowledgement for the beam tracking request and no negative acknowledgement for the beam tracking request is transmitted.

In another embodiment of the present disclosure, the beam tracking request may be transmitted with CRC codes.

In a further embodiment of the present disclosure, the beam tracking request may be transmitted between two full beam reports.

In a still further embodiment of the present disclosure, the beam identification information may indicate a beam identification based on a serving beam set.

In a yet further embodiment of the present disclosure, the beam tracking request may further contain beam channel quality information and the beam channel quality information is indicated by a beam quality pattern representing a quality relationship of reported beams with respect to survived beams in the serving beam set.

In another embodiment of the present disclosure, wherein the beam tracking request may correspond to any operation of: beam switching; failed beam removing; new beam adding; and beam recovery with no further beam management.

Hereinbefore, apparatuses 1400 and 1500 are described with reference to FIGS. 14 and 15 in brief. It can be noted that the apparatuses 1400 and 1500 may be configured to implement functionalities as described with reference to FIGS. 4 to 13. Therefore, for details about the operations of modules in these apparatuses, one may refer to those descriptions made with respect to the respective steps of the methods with reference to FIGS. 4 to 13.

It is further noted that components of the apparatuses 1400 and 1500 may be embodied in hardware, software, firmware, and/or any combination thereof. For example, the components of apparatuses 1400 and 1500 may be respectively implemented by a circuit, a processor or any other appropriate selection device.

Those skilled in the art will appreciate that the aforesaid examples are only for illustration not limitation and the present disclosure is not limited thereto; one can readily conceive many variations, additions, deletions and modifications from the teaching provided herein and all these variations, additions, deletions and modifications fall the protection scope of the present disclosure.

In addition, in some embodiment of the present disclosure, apparatuses 1400 and 1500 may comprise at least one processor. The at least one processor suitable for use with embodiments of the present disclosure may include, by way of example, both general and special purpose processors already known or developed in the future. Apparatuses 1400 and 1500 may further comprise at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compilable or interpretable programming languages. In accordance with embodiments, the computer executable instructions may be configured, with the at least one processor, to cause apparatuses 1400 and 1500 to at least perform operations according to the method as discussed with reference to FIGS. 4 to 13 respectively.

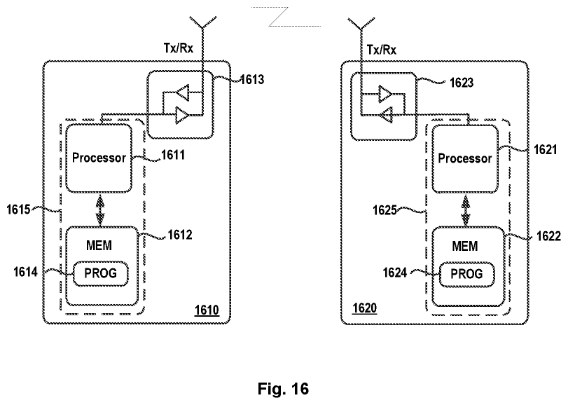

FIG. 16 further illustrates a simplified block diagram of an apparatus 1610 that may be embodied as or comprised in a network device like a base station (gNB) in a wireless network and an apparatus 1620 that may be embodied as or comprised in a terminal device like UE as described herein.

The apparatus 1610 comprises at least one processor 1611, such as a data processor (DP) and at least one memory (MEM) 1612 coupled to the processor 1611. The apparatus 1610 may further comprise a transmitter TX and receiver RX 1613 coupled to the processor 1611, which may be operable to communicatively connect to the apparatus 1620. The MEM 1612 stores a program (PROG) 1614. The PROG 1614 may include instructions that, when executed on the associated processor 1611, enable the apparatus 1610 to operate in accordance with embodiments of the present disclosure, for example the method 400. A combination of the at least one processor 1611 and the at least one MEM 1612 may form processing means 1615 adapted to implement various embodiments of the present disclosure.

The apparatus 1620 comprises at least one processor 1621, such as a DP, and at least one MEM 1622 coupled to the processor 1621. The apparatus 1620 may further comprise a suitable TX/RX 1623 coupled to the processor 1621, which may be operable for wireless communication with the apparatus 1610. The MEM 1622 stores a PROG 1624. The PROG 1624 may include instructions that, when executed on the associated processor 1621, enable the apparatus 1620 to operate in accordance with the embodiments of the present disclosure, for example to perform the method 1300. A combination of the at least one processor 1621 and the at least one MEM 1622 may form processing means 1625 adapted to implement various embodiments of the present disclosure.

Various embodiments of the present disclosure may be implemented by computer program executable by one or more of the processors 1611, 1621, software, firmware, hardware or in a combination thereof.

The MEMs 1612 and 1622 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 1611 and 1621 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-38. (canceled)

39. A method performed by a terminal device, comprising:
transmitting, to a network device, a Physical Random Access Channel (PRACH) if a beam failure is detected, and
receiving, from the network device, a Physical Downlink Control Channel (PDCCH) in response to the PRACH, wherein the PDCCH is scrambled by an identity specific for the terminal device.

40. The method of claim 39, wherein the PDCCH is received based on resource specific for a beam failure recovery.

41. The method of claim 39, wherein the PDCCH is received in a resource indicated by the PRACH.

42. The method of claim 39, wherein the PRACH indicates a beam identification information for a beam failure recovery.

43. The method of claim 42, wherein the beam identification information indicates a new beam for the beam failure recovery.

44. The method of claim 39, further comprising receiving, from the network device, a configuration related with a beam failure recovery via RRC signaling.

45. The method of claim 44, wherein the PRACH is transmitted based on the configuration.

46. The method of claim 39, further comprising:
performing an operation for receiving a downlink transmission after a time offset from a reception of the PDCCH.

47. The method of claim 46, wherein performing the operation comprises considering to receive the downlink transmission using a beam for the reception of the PDCCH.

48. A method perform by a network device, comprising:
receiving, from a terminal device, a Physical Random Access Channel (PRACH) indicating information related with beam failure;
transmitting, to the terminal device, a Physical Downlink Control Channel (PDCCH) in response the PRACH, wherein the PDCCH is scrambled by identity specific for the terminal device.

49. The method of claim 48, wherein the PDCCH is transmitted in resources specific for a beam failure recovery.

50. The method of claim 48, wherein the PDCCH is transmitted in a resource indicated by the PRACH.

51. The method of claim 48, wherein the PRACH indicates a beam identification information for a beam failure recovery.

52. The method of claim 51, wherein the beam identification information indicates a new beam for the beam failure recovery.

53. The method of claim 48, further comprising transmitting, to the terminal device, a configuration related with a beam failure recovery via RRC signaling.

54. The method of claim 53, wherein the PRACH is received based on the configuration.

55. The method of claim 39, further comprising:
performing an operation for transmitting a downlink transmission after a time offset from the transmission of the PDCCH.

56. The method of claim 55, further comprising transmitting the downlink transmission using a beam for the transmission of the PDCCH.

57. A terminal device comprising a processor configured to:
transmit, to a network device, a Physical Random Access Channel (PRACH) if a beam failure is detected, and
receive, from the network device, a Physical Downlink Control Channel (PDCCH) in response to the PRACH, wherein the PDCCH is scrambled by an identity specific for the terminal device.

58. A network device comprising a processor configured to:
receive, from a terminal device, a Physical Random Access Channel (PRACH) indicating information related with beam failure;
transmit, to the terminal device, a Physical Downlink Control Channel (PDCCH) in response the PRACH, wherein the PDCCH is scrambled by identity specific for the terminal device.
